(19) United States
(12) Patent Application Publication
(10) Pub. No.: US 2005/0183103 A1
(43) Pub. Date: Aug. 18, 2005

(54) Disk device having clamper on board

(75) Inventors: Masahiko Nishide, Takefu-city (JP); Kinichi Tsunemoto, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD, Takefu-city (JP)

(21) Appl. No.: 11/053,883

(22) Filed: Feb. 10, 2005

(30) Foreign Application Priority Data
Feb. 17, 2004 (JP) 2004-039874

(51) Int. Cl. G11B 17/03

(52) U.S. Cl. 720/604

(57) ABSTRACT

The invention provides a disk device that is excellent in strength, an easy installation and adjustment performed in the manufacturing process, an easy maintenance and repair work performed, and the safety during repair and maintenance work further achieving a cost reduction.

A clamper 41 is provided and a board 12 having an area in which at least the irradiation range of laser light emitted by an optical pickup is covered is fixed to a frame 11 that constitutes a disk device 1 by screwing or the like, thereby improving the strength, safety, and workability of the disk device 1.

### BACKGROUND OF THE INVENTION

1. Field of the Invention

The present invention relates to a disk device that performs the playing and picture recording on an optical disk having a clamper on a board, in which the clamper supports a disk medium by sandwiching the disk medium between the clamper itself and the turntable.

2. Description of the Related Art

In recent years, in response to various kinds of users' needs, a disk device has been built not only in a DVD player, a CD player, and the like, but also in the main body of a television receiver and the like, and its application has been extended to a wide range. Further, these electrical equipments and the like have become smaller and thinner year by year.

Because in the interior of such electrical equipments and the like having small design and thin design, the space is insufficient and various devices and parts are mounted at high densities, the workability tend to decrease in the installation and adjustment of devices and parts in the manufacturing process, during the maintenance, and in repair work of the devices and parts. Therefore, a disk device built in the electrical equipments and the like is required not only to meet the requirements for small design, but also to provide an easy installation and adjustment performed in the manufacturing process, an easy maintenance and repair work performed, and the safety during maintenance, repair work, and the like.

Japanese Patent Laid-Open Publication No. 2003-059154 discloses a disk device in which the requirements for an easy installation and adjustment are performed in the manufacturing process, an easy maintenance and repair work is performed, a reduction in the cost of products and the like are to be met by simplifying the structure of the device by reducing the number of parts, and the like.

Japanese Patent Laid-Open Publication No. 07-272474 discloses a conventional technique that enables the inspection of a disk device to be easily performed during the service check of the disk device, such as repair, and Japanese Patent Laid-Open Publication No. 10-334643 discloses a conventional technique that facilitates assembling during the manufacture of electrical equipments and the like.

### SUMMARY OF THE INVENTION

In the conventional technique disclosed in Patent Reference 1 or Patent Reference 2, during the service check such as repair, it is necessary to remove a disk device from an electrical equipment and the like and to expose the rear surface side of the disk device by tilting the disk device, and the work must also be carried out by taking a peep into the disk device, with the disk device kept tilted. Thus, the work was very complicated.

Further, a frame that constitutes a disk device is usually formed by monolithic molding from resin and has substantially a box-like shape. However, the front portion of the frame must be opened in order to load and unload a disk medium and the top surface portion has only a support portion to support a clamper. Thus, structurally, the frame has many open parts and it could not be said that the strength of the frame is enough. Therefore, a conventional disk device had the problem that deformation and twisting may occur in the disk device when heat and an external force are applied, which was a fear, and that the disk device may not normally operate when deformation and twisting occur in the disk device. In recent years, electrical equipments have become smaller and thinner and against this background, parts and devices that generate heat is being provided in higher densities in the interior of electrical equipments. Therefore, the weight and heat of each part are applied in a concentrated manner and the above-described problem tends to become more remarkable.

The present invention has been devised in view of the above-described problems and the object of the invention is to provide a disk device having a damper on a board that is excellent in strength, and providing an easy installation and adjustment performed in the manufacturing process, an easy maintenance and repair work performed, and the safety during repair and maintenance work, further achieving a cost reduction.

The disk device having a damper on a board according to the first aspect of the invention is a disk device that comprises a turntable that rotates and drives a disk medium, a damper that supports the disk medium by sandwiching the disk medium between the damper itself and the turntable, a board that controls the disk device, and a frame in which these component parts are installed, with the clamper being provided on the board.

According to the above-described arrangement, because the clamper is held by the board, it is unnecessary to separately provide a mechanism to support the clamper.

The disk device having a damper on a board according to the second aspect of the invention is that in the disk device having a damper on a board according to the first aspect of the invention, a supporting hole that supports the damper is provided in the board and that the damper is provided in the supporting hole.

According to the above-described arrangement, the damper can be supported by the board owing to a simple arrangement that the supporting hole is provided in the board.

The disk device having a damper on a board according to the third aspect of the invention is that in the disk device having a clamper on a board according to the first or the second aspect of the invention, a top end portion of either or both of side walls of the frame that constitutes the disk device is provided with one or multiple protrusions to fit into an attaching hole provided in the board having the damper and a top end portion of either or both of side walls of the frame is provided with one or multiple screw holes to screw the board having the clamper, whereby the board having the damper is attached to the disk device.

According to the above-described arrangement, by fitting the hole for joining to the frame that is provided in the board having the damper to the protrusion provided on the top end portion of the side wall of the frame, the positioning of the board with respect to the disk device can be accurately performed and further by screwing, the board is firmly fixed to the frame.

The disk device having a damper on a board according to the fourth aspect of the invention is that in the disk device having a damper on a board according to any one of the first to the third aspect of the invention, at least the irradiation range of laser light that is emitted by an optical pickup is covered by the board having the clamper.

According to the above-described arrangement, the laser light emitted by the optical pickup is shut off by the board and preventing the outside of the disk device from directly irradiated.

According to the disk device having a damper on a board as described in the first aspect of the invention that comprises a turntable that rotates and drives a disk medium, a damper that supports the disk medium by sandwiching the disk medium between the damper itself and the turntable, a board that controls the disk device, and a frame in which these component parts are installed, with the clamper being provided on the board, because the damper is held by the board, it is unnecessary to provide a damper supporting portion that supports the damper in the top end portion of the frame that constitutes the disk device and it is possible to keep the top surface portion of the frame in an open condition. Therefore, the shape of a mold that molds the frame is simplified and a cost reduction can be achieved. Furthermore, because the top surface portion of the frame is in an open condition, when a traverse unit or the like is attached to the disk device in the manufacturing process of the disk device, the attaching work can be easily performed from above the disk device, hence workability is improved, and it is possible to give flexibility to work steps. In addition, during repair and maintenance work, the work can be done easily because the board is mounted on top of the disk device, and by removing the board, the clamper can also be simultaneously removed so that the top surface portion of the disk device comes to an open condition, with the result that the replacement of parts within the disk device can be easily performed without removing the main body of the disk device from an electrical equipment or the like in which the disk device is built-in. Thus, the work time can be substantially shortened.

According to the disk device having a damper on a board as described in the second aspect of the invention, which is the disk device having a damper on a board according to the first aspect of the invention in which a supporting hole that supports the damper is provided in the board and that the damper is provided in the supporting hole, with the damper itself, can be an existing damper and “the board having the clamper” can be realized only by a simple arrangement in which the supporting hole is provided in the board, thereby reducing the cost. In addition, compared to the damper supporting portion monolithically formed with the frame, the work of attaching the damper is easy.

According to the disk device having a damper on a board as described in the third aspect of the invention, which is the disk device having a damper on a board as described in the first or the second aspect of the invention in which a top end portion of either or both of side walls of the frame that constitutes the disk device is provided with one or multiple protrusions to fit into an attaching hole provided in the board having the damper and a top end portion of either or both of side walls of the frame is provided with one or multiple screw holes to screw the board having the clamper, whereby the board having the damper is attached to the disk device, the positioning of the board is accurately performed by fitting the hole for joining to the frame that is provided in the board having the damper to the protrusion provided on the top end portion of the side wall of the frame by further screwing, the board is firmly fixed to the frame. Hence, the disk device has an integrated arrangement of the frame and the board with few open portions, and therefore, strength is improved, with the result that it is possible to prevent malfunctions of the device due to deformation and twisting from occurring. Furthermore, because deformation and twisting are small, it is possible to minimize plays in moving parts and the like and the device can be miniaturized as much as possible. In addition, in some combinations of the protrusion to fit into the hole provided in the board and the screw hole to screw the board, it is also possible to ensure that a control board that can be easily attached by use of only one screw, and therefore, man-hours of work and cost can be reduced.

According to the disk device having a damper on a board as described in the fourth aspect of the invention, which is the disk device having a damper on a board according to any one of the first to third aspect of the invention, in which at least the irradiation range of laser light that is emitted by an optical pickup is covered by the board having the clamper, the laser light emitted by the optical pickup is shut off by the board and preventing the outside of the disk device from being directly irradiated. Therefore, it is possible to effectively prevent an accident such that an operator looks at laser light straightly by mistake during inspection and repair work and the like. Further, because the optical pickup is covered by the board, an optical head of the pickup can be made dust-proof.

### BRIEF DESCRIPTION OF THE DRAWINGS

FIG. 1 is a perspective view of a disk device having a clamper on a board in Embodiment 1;

FIG. 2 is a plan view of a disk device having a clamper on a board in Embodiment 1;

FIG. 3 is a plan view of FIG. 1 without the board 12 of FIG. 2;

FIG. 4 is a partially exploded perspective view of a disk device having a clamper on a board in Embodiment 1;

FIG. 5 is a perspective view of a DVD player, which is an example of an electrical equipment provided with a disk device having a clamper on a board in Embodiment 1;

FIG. 6 is a perspective view that shows a conventional example of a disk device;

FIG. 7 is a plan view that shows a conventional example of a disk device.

### DETAILED DESCRIPTION OF THE PREFERRED EMBODIMENTS

Now, the preferred embodiment of the invention will be described below with reference to the drawings. Please note that the following embodiment is a mere example for embodying the invention and is not intended to limit the invention within the scope of the embodiment.

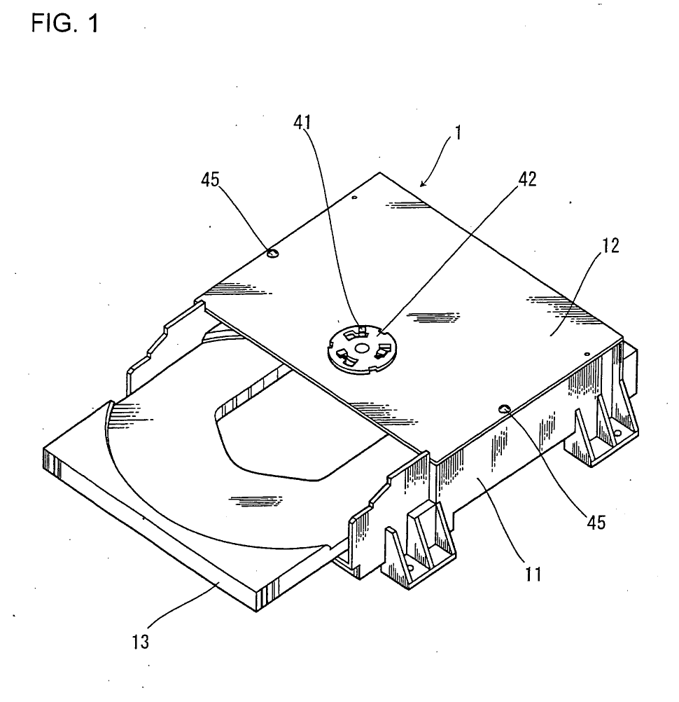

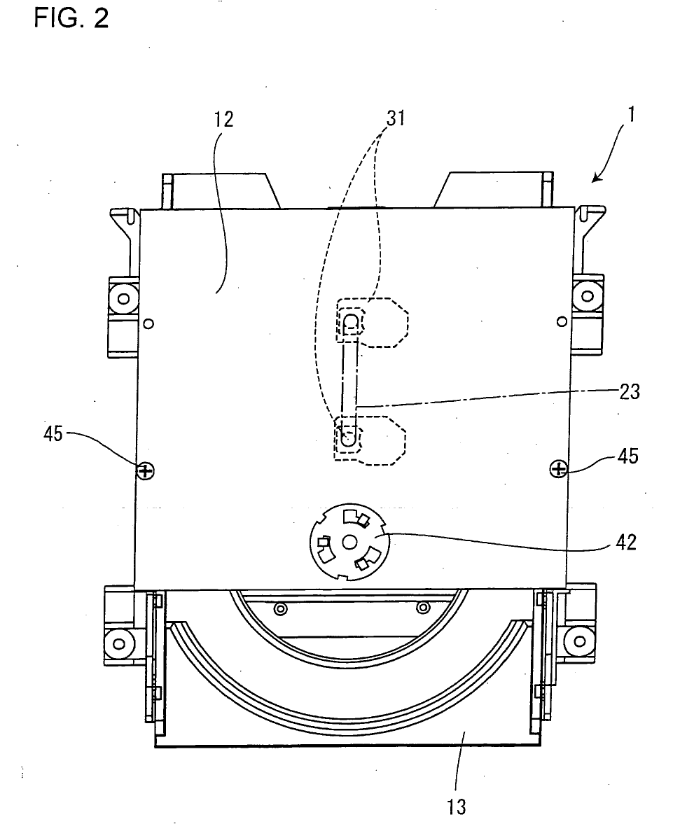

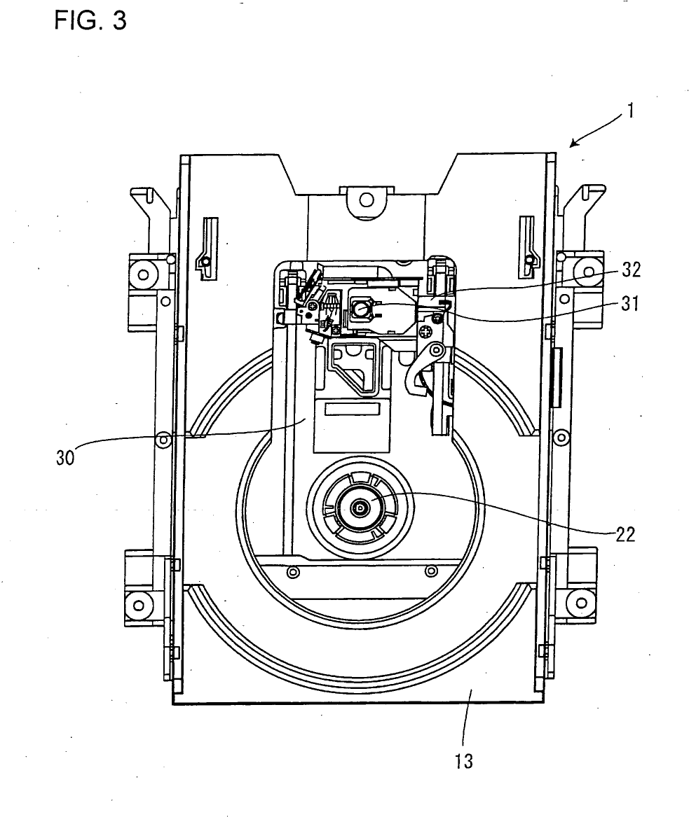

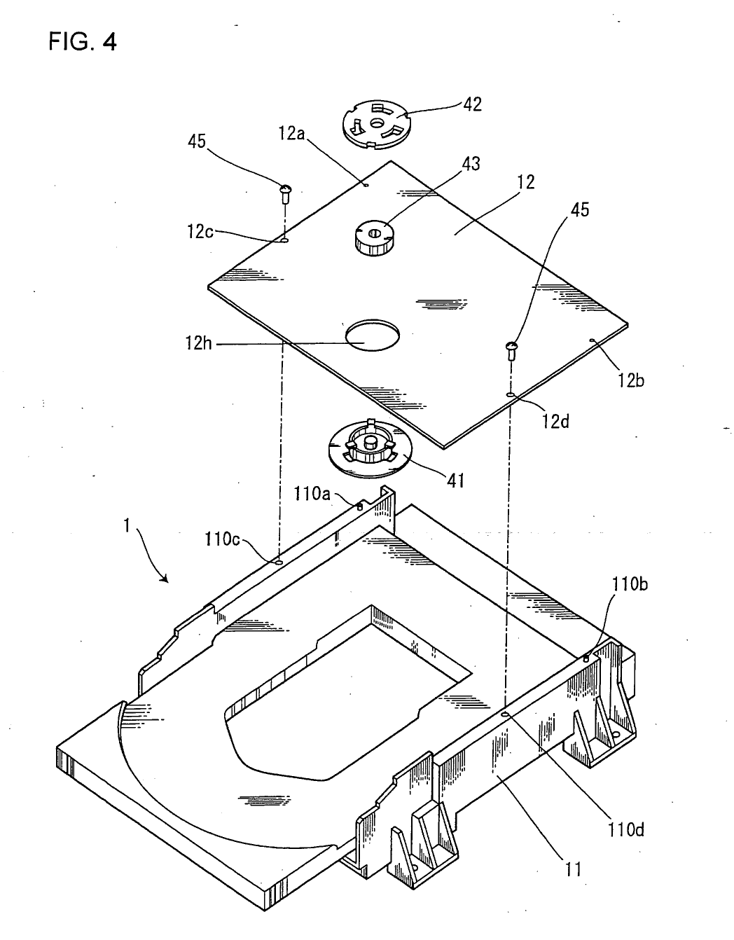

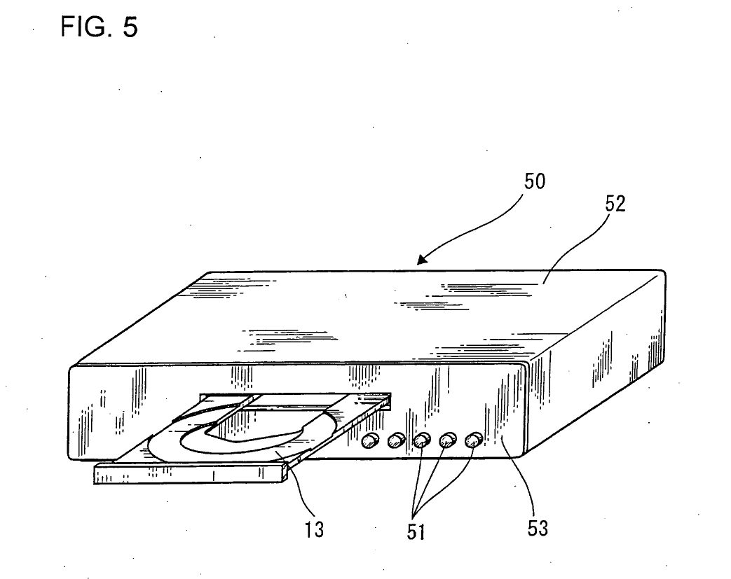

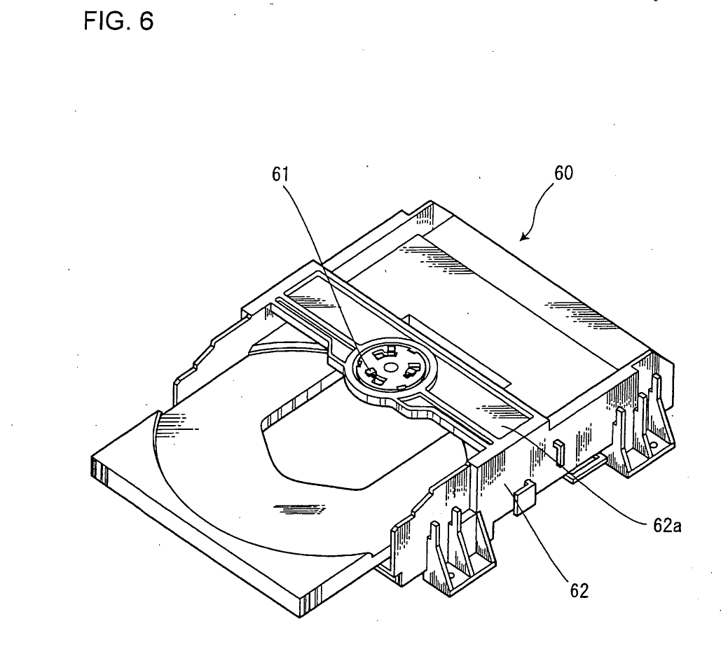

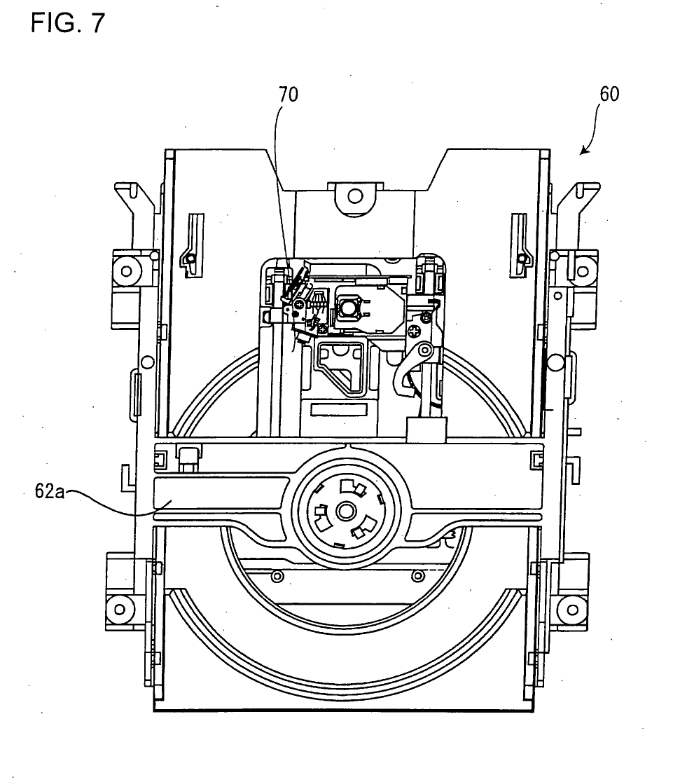

FIG. 1 is a perspective view of a disk device having a clamper on a board in this embodiment, FIG. 2 is a plan view of this disk device, and FIG. 3 is a plan view of this disk device without the board 12. FIG. 4 is a partially exploded perspective view of a disk device having a clamper on a board in this embodiment, and FIG. 5 is a perspective view of a DVD player, which is an example of an electrical equipment provided with a disk device having a clamper on aboard in this embodiment. FIG. 6 is a perspective view that shows a conventional example of a disk device and FIG. 7 is a plan view of the disk device.

As shown in FIG. 1, in a disk device having a clamper on a board 1 (hereinafter referred to simply as a disk device 1), a board 12 is provided on top of a frame 11 the whole of which is generally made of resin, and a tray 13 on which a disk is to be placed is provided so as to be slidable with respect to the frame 11. As shown in FIGS. 2 and 3, the disk device 1 is provided with an optical pickup 31, an optical pickup feed mechanism 32, and the like, and under a turntable 22 and a turntable 22, a spindle motor (not shown) that rotates the turntable 22 and the like are provided. The board 12 in this embodiment is a board that performs the control of the optical pickup feed mechanism 32, the spindle motor, and the like, the control of signals that are input/output to/from the optical pickup 31 and the like, and on the surface of the turntable 22 there is provided a magnetic material that supports a disk medium by sandwiching the disk medium between the magnetic material itself and a magnet 43 provided on a damper 41.

As shown in FIG. 4, on the top end portions of both side walls of the frame 11, protrusions 110a, 110b to fit into attaching holes 12a, 12b provided in the board 12 are provided, and screw holes 110c, 110d to screw the control board 12 through the attaching holes 12c, 12d are provided. The damper 41, on which the magnet 43 is placed, is loosely fitted in the board 12 by being inserted into the supporting hole 12h of the board 12 and covered with a damper cover 42.

According to the above-described arrangement, the positioning of the board 12 with respect to the disk device 1 can be accurately performed by fitting the attaching holes 12a, 12b provided in the board 12 onto the protrusions 110a, 110b provided on the top end portions of the side walls of the frame, and at the same time, the board 12 can be firmly fixed to the frame 11 by screwing the board 12 by use of screws 45 through the attaching holes 12c, 12d. Hence, the disk device 1 has an integrated construction with the frame 11 and the board 12 with few open portions and, therefore, rigidity is high, with the result that it is possible to prevent malfunctions of the device due to deformation and twisting from occurring. Furthermore, because deformation and twisting are small, it is possible to minimize plays in moving parts and the like and the disk device 1 can be miniaturized as much as possible. As component parts, such as the damper 41, the damper cover 42, and the magnet 43, existing ones can be used as they are, and therefore, general versatility is high.

As shown in FIGS. 6 and 7, in a conventional disk device 60, a clamper supporting portion 62a that supports the damper 61 are monolithically molded with a frame 62, and therefore, it could not be the that during the manufacturing of the disk device 60, the work of attaching the damper 61 to the disk device 60 and the work of attaching a traverse unit 70 are good. Moreover, during repair and maintenance work, complicated work was required for the same reason.

On the other hand, according to the disk device 1 of this embodiment, as shown in FIGS. 3 and 4, the top surface of the disk device 1 is in an open condition when the board 12 is not yet attached to the disk device 1. Therefore, when the traverse unit 30, which is provided with the optical pickup 31, the pickup feed mechanism 32, the turntable 22, and the like, or the like is attached to the disk device 1 in the manufacturing process of the disk device 1, the work can be easily performed from above the disk device 1, hence workability is improved, and it is possible to give flexibility to work steps. Moreover, during repair and maintenance, the work is very easy because the board 12 is placed on top of the disk device 1. In addition, by removing the board 12, the top surface portion of the disk device 1 comes to an open condition, with the result that the replacement of parts provided within the disk device 1 can be easily performed without removing the main body of the disk device 1 from an electrical equipment (a chassis, for example, of a DVD player 50) in which the disk device 1 is built-in. Thus, the work steps and work time can be substantially shortened.

Furthermore, as shown in FIG. 2, the board 12 has an area that covers the irradiation range 23 of laser light emitted by the optical pickup 31, and therefore, it is possible to effectively prevent an accident such that an operator looks at laser light straightly by mistake. The laser output is high particularly in recording type disk devices, which is dangerous. In recent years, the laser output has tended to increase further due to the doubling of the recording speed. Therefore, it is effective and necessary to ensure that the outside of the disk device is not directly irradiated by a laser in this manner. In addition, because the optical pickup 31 is covered by the board 12, the optical pickup 31 can be made dust-proof.

Although in this embodiment, descriptions were given of a tray type disk device, however, the invention is not limited to this type of disk device, and the invention can also be applied to a slot in type disk device in which a disk is inserted into the device by use of transfer rollers and a changer type disk device in which multiple disks can be housed within the device.

1. A disk device having a damper on a board, in which the disk device comprises a turntable that rotates and drives a disk medium, a damper that supports the disk medium by sandwiching the disk medium between the damper itself and the turntable, a board that controls the disk device, and a frame in which these component parts are installed, with the damper being provided on the board.

2. The disk device having a damper on a board according to claim 1, in which a supporting hole that supports the damper is provided in the board and that the damper is provided in the supporting hole.

3. The disk device having a damper on a board according to claim 1, in which a top end portion of either or both of side walls of the frame that constitutes the disk device is provided with one or multiple protrusions to fit into an attaching hole provided in the board having the damper and a top end portion of either or both of side walls of the frame is provided with one or multiple screw holes to screw the board having the clamper, whereby the board having the damper is attached to the disk device.

4. The disk device having a damper on a board according to claim 1, in which at least the irradiation range of laser light that is emitted by an optical pickup is covered by the board having the clamper.

5. The disk device having a damper on a board according to claim 2, in which a top end portion of either or both of side walls of the frame that constitutes the disk device is provided with one or multiple protrusions to fit into an attaching hole provided in the board having the damper and a top end portion of either or both of side walls of the frame is provided with one or multiple screw holes to screw the board having the clamper, whereby the board having the damper is attached to the disk device.

6. The disk device having a damper on a board according to claim 2, in which at least the irradiation range of laser light that is emitted by an optical pickup is covered by the board having the clamper.

7. The disk device having a damper on a board according to claim 3, in which at least the irradiation range of laser light that is emitted by an optical pickup is covered by the board having the clamper.
